(19) United States
(12) Patent Application Publication
(10) Pub. No.: US 2017/0279121 A1
(43) Pub. Date: Sep. 28, 2017

(54) Systems And Methods For Energy Storage Cells Having Improved Intercalation

(71) Applicant: Achilles Technical Solutions LLC, Scottsdale, AZ (US)

(72) Inventor: Michael Rhodig, Scottsdale, AZ (US)

(21) Appl. No.: 15/469,412

(22) Filed: Mar. 24, 2017

Related U.S. Application Data
(60) Provisional application No. 62/313,007, filed on Mar. 24, 2016.

(51) Int. Cl. H01M 4/587

(52) U.S. Cl. CPC H01M 4/587

(57) ABSTRACT

An energy storage cell includes an enclosure, a cathode, a separator, and an anode in electro-chemical communication with each other to produce electric current. The cathode, separator, and anode are located within the enclosure. The anode includes a plurality of components for improved density and improved extent of content organized as graphene. Each component is formed as a tape. The tape includes planar sheets of carbon organized in a primarily perpendicular line orientation.

### CROSS-REFERENCE TO RELATED APPLICATIONS

This application claims the benefit of priority under 35 U.S.C. §119(e) from U.S. provisional application Ser. No. 62/313,007 filed on Mar. 24, 2016 incorporated herein by reference.

### BRIEF DESCRIPTION OF THE DRAWING

FIG. 1 is a plan view of a packaged energy storage cell, according to various aspects of the present invention;

FIG. 2 is a cross-section plan view of the cell of FIG. 1;

FIG. 3 is a cross-section diagram of various arrangements of components of an electrode of FIG. 2;

FIG. 4 is a cross-section diagram of one component of an electrode of FIG. 2;

FIG. 5 is a perspective diagram of planar sheets of carbon of the component of FIG. 4;

FIGS. 6A and 6B form a flow diagram of various methods, according to various aspects of the present invention; and

FIGS. 7 and 6B form a flow diagram of various methods, according to various aspects of the present invention.

### DETAILED DESCRIPTION OF THE PREFERRED EMBODIMENTS

Energy storage cells provide electrical energy in the form of an electrical current through a load until energy stored in the cell in a charged condition is depleted to a discharged condition. Rechargeable energy storage cells accept a charging current to restore the energy cell from the discharged condition to the charged condition.

Some conventional energy storage cells utilize a mechanism referred to as intercalation (insertion) and deintercalation (extraction). For example, a conventional energy storage cell of the type known as a lithium ion cell has two electrodes herein referred to as the anode (negative) and cathode (positive) with reference to discharging. During charging, lithium ions and electrons are produced at the cathode. During charging, in a circuit comprising a source and the cell, electrons flow from the source into the anode, as lithium ions from the cathode intercalate within the open crystalline structure of the anode. Electrons from the cathode return to the source. During discharging, lithium ions and electrons are produced at the anode. During discharging, in a circuit comprising a load and the cell, electrons flow from the anode and through the load as lithium ions are deintercalated from the anode (the reverse of intercalation). The ions from the anode combine with the cathode as the cathode accepts electrons from the load. The anode and cathode are electrically isolated from each other to prevent electrons from passing therebetween within the energy storage cell.

Other energy storage cells operate in a manner as discussed above with ions other than lithium (e.g., sodium, alkali metals).

Intercalation (insertion) and deintercalation (extraction) involve movement of ions through open crystalline material. Physical and/or electro-chemical interferences with that movement in an energy storage cell adversely affect some of the characteristics of energy storage cells (e.g., energy density, internal resistance, operating temperature, charging rates, discharging rates, useful life, number of charge/discharge cycles during useful life).

According to various aspects of the present invention, improved structures for open crystalline material reduce one or more physical and/or electro-chemical interferences to the movement of ions during intercalation and/or extraction. For example, such improved structures may be incorporated in the anode and/or cathode of an energy storage cell. In the discussion below, improved structures are used in the anode of a lithium ion energy storage cell. Such cells may be combined to form a lithium ion battery (i.e., a combination of cells), also called a battery pack.

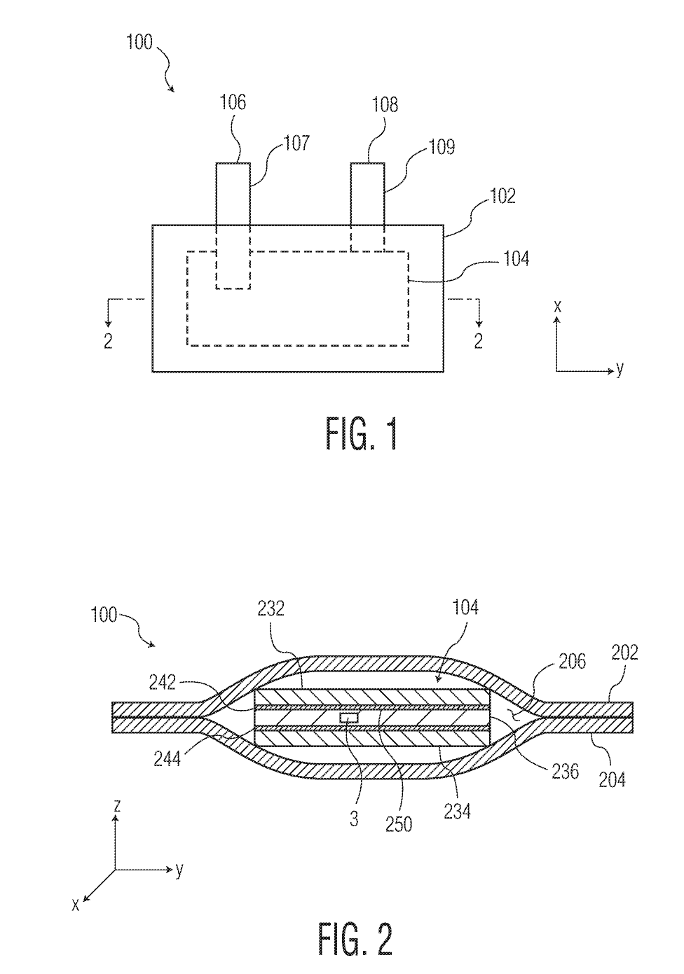

For example, energy storage cell 100 of FIGS. 1-7 utilizes improved structures for intercalation and deintercalation in an electrode of the cell. Cell 100 includes enclosure 102, assembly 104, cathode subassembly 106, and anode subassembly 108. Cell 100 performs the functions discussed above with reference to the energy storage cell of the type known as a lithium ion cell.

An enclosure isolates the chemistry of cell 100 from its environment. For example, enclosure 102 isolates lithium salts, lithium ions, and lithium alloys of the cell from water. Isolation ensures that these materials do not participate in chemical reaction(s) that would damage the energy storage mechanism of cell 100 and may present a hazard to the environment near cell 100. In one configuration, a film (e.g., dry laminated aluminum) is sealed (e.g., welded) along a perimeter of enclosure 102 to form a pouch having an interior and exterior to accomplish enclosing of assembly 104 in the interior of enclosure 102. In another configuration, a film is folded on one edge to form an interior (e.g., pocket) and exterior of enclosure 102 and sealed along the remainder of the perimeter of enclosure 102. Conventional materials and technologies may be used (e.g., materials and pouches as marketed by Targray Technology International Inc., Kirkland, Canada).

Enclosure 102 may be flexible as discussed above or rigid. The rigidity of enclosure 100 may provide mechanical protection to assembly 104 from environmental forces (e.g., sheer, extension, compression, impact, vibration) that could otherwise fracture assembly 104.

Enclosure 102 may provide thermal insulation, thermal conductivity, electro-magnetic shielding, and/or optical shielding to facilitate maintaining desired operating conditions within enclosure 100 for proper operation of assembly 104. Conventional materials and technologies may be used.

Cathode subassembly 106 includes tab 107 and cathode portions 232 and 234. Tab 107 is electrically and mechanically coupled to cathode portions 232 and 234. For example, tab 107 may be formed of aluminum that is attached to cathode portions 232 and 234 (e.g., brazed, welded, riveted, adhered with conductive adhesive).

Anode subassembly 108 includes tab 109 and anode 236. Tab 109 is electrically and mechanically coupled to anode 236. For example, tab 109 may be formed of copper that is attached to anode 236 at a location apart from separators 242 and 244 (e.g., brazed, welded, riveted, adhered with conductive adhesive).

Cathode subassembly 106 and anode subassembly 108 conduct electrical current into and out of assembly 104 through enclosure 102 (e.g., through one or more portions of the perimeter). Cathode subassembly 106 and anode subassembly 108 may include conventional circuit terminals (e.g., conductive tabs). A terminal mechanically and electrically couples assembly 104 to circuitry outside enclosure 102. Terminals of any conventional material may be used (e.g., copper, aluminum) and may facilitate circuit connections using conventional technologies (abutment, soldering, sonic welding, sliding contact, pin, socket, screw, snap, coaxial). Terminals transfer energy between assembly 104 and circuitry (e.g., load, source) external to energy storage cell 100.

In other configurations, not shown, transferring energy as discussed above is accomplished with other conventional coupling technologies (magnetic field, electric field, electromagnetic radiation, light, heat) with suitable additional circuitry and/or transducers within enclosure 102. Enclosure 102 in such configurations incorporates suitable conventional materials, circuits, and/or technologies to facilitate such coupling (e.g., coil, antenna, port, window, heat exchanger).

An assembly for an energy storage cell stores and releases electrical energy. For example, assembly 104 receives and sources electric current through terminals as discussed above at a potential difference between the terminals. For example, assembly 104 of FIG. 2 (not to scale) is maintained (e.g., supported, confined) within an interior 206 of enclosure 102.

Films 202 and 204, forming enclosure 102, are sealed to each other to define the interior 206. The volume of interior 206 may be substantially the same as the volume of assembly 104. The volume of interior 206 may be somewhat different from the volume of assembly 104 to allow, for example, for expansion and contraction of assembly 104 and/or enclosure 102.

Assembly 104 includes cathode portions 232 and 234, anode 236, and separators 242 and 244. Conventional separators may be used (e.g., polypropylene, polyethylene) to ensure physical and electrical isolation of anode 236 from cathode portions 232 and 234. Cathode portions 232 and 234 are coupled for ionic transport through separators 242 and 244 respectively. Anode 236 is coupled for ionic transport through separators 242 and 244. Conventional technologies may be used to accomplish coupling for ionic transport (e.g., abutting a surface of a separator, contacting an electrolyte on a surface of a separator, wetting by a gel or liquid on a surface of a separator). Assembly 104 is illustrated for clarity of description as a simple stack (i.e., an ordered arrangement on the z-axis of components 232, 242, 236, 244, and 234). For clarity of description, the stack includes components of uniformly sized materials (e.g., wafers, coatings, deposits) having uniform respective thickness between primarily parallel x-y planar surfaces of the components 232, 242, 236, 244, and 234. Components of the stack may be rectangular to facilitate manufacturing. For clarity of description, assembly 104 includes a stack that includes one anode.

Thickness (in the z-axis) of components (e.g., wafers, coatings, deposits) of the stack may conform to conventional dimensions as required for cell performance (e.g., charging rate, discharging rate, number of charge/discharge cycles in life of cell, internal resistance). For example, anode 236 may have thickness in the range from 30 to 320 microns, preferably about 60 microns. A cathode portion 232 or 234 may have thickness in the range from 50 to 320 microns, preferably about 60 microns. A separator 242 and 244 may have a thickness in the range from 5 to 80 microns (e.g., porous separator marketed as model 2400 by Celgard, LLC, Charlotte, N.C.), preferably about 25 microns. The separator may be saturated with electrolyte. Thicknesses of the components of assembly 104 may correspond to conventional technologies, for example, of the type utilized in cells marketed by Samsung SDI or LG Chem for use in electric vehicles, that are sized to meet specifications including capacity and energy density.

According to various aspects of the present invention, assembly 104 may have a non-flat configuration, for example, wherein a cross-section of the stack, may form a curve or some or all of a perimeter of a polygon, oval, or circle. To accomplish desired edge characteristics, stacked materials in other configurations are not of uniform size (e.g., anode extends beyond separator and/or beyond cathode portion(s), cathode portion(s) extend beyond separator and/or anode).

According to various aspects of the present invention, assemblies corresponding to assembly 104 include multiple anodes with commensurate inclusion of additional cathode portions, and/or separators. The multiple anodes may be located in one common stack and/or distributed on separators coupled for ionic transport with one or more cathode portions.

Cathode portions 232 and 234 may include conventional materials formed using conventional technologies. For example, cathode portions 232 and 234 include one or more lithium compounds (e.g., LiCoO₂, LiNiO₂, LiNiTiO₂, LiNiCoO₂, LiNiCoAlO₂, LiMn₂O₄, LiMnO₂, LiV₂O₅, LiV₆O₁₃, LiTiS₂, Li₃FeN₂, Li₇VN₄, Li₇MoN₄, Li₂ZrN₂). Cathode portions 232 and 234 may be of the type marketed by Targray Technology, Inc.

A separator for an energy storage cell provides a barrier to the flow of electrons but permits a flow of ions (i.e., ionic transport) through the separator. The separator may be porous. Pores of a separator may be filled with non-conductive material to facilitate ionic transport through the separator. For example, separators 242 and 244 may include microporous polyolefin membrane (e.g., material marketed as model 2400 by Celgard, LLC, Charlotte, N.C.). Separators 242 and 244 may include a non-aqueous aprotic organic electrolyte. Such an electrolyte may include a solution of a solute (e.g., LiPF₆, LiBF₄, LiAsF₆, LiCF₃SO₃, LiN(CF₃SO₂)₂ or LiClO₄) dissolved in a solvent (e.g., propylene carbonate, ethylene carbonate, diethyl carbonate, dimethyl carbonate, ethyl methyl carbonate). Electrolyte materials of the type marketed by Targray Technology, Inc. may be used.

A carbon-carbon composite material includes any structure comprising a carbon matrix that is reinforced with carbon fiber. The carbon matrix may be formed by pyrolysis of an organic precursor, for example, by carbonizing or graphitizing of a carbonaceous pitch. In another implementation according to various aspects of the present invention, the composite material is not a carbon-carbon composite due to use of a binder that is not carbonized and/or graphitized.

According to various aspects of the present invention, an electrode of an energy storage cell includes a material formed from one or more components of tape serving as the carbon fiber content. The material may be a carbon-carbon material. The tape may have a narrow thickness, a wider width, and a longitudinal axis that follows the length of the tape. The components may be arranged primarily parallel with the longitudinal axis of the tape. The components may have lengths suitable for defining a perimeter of the desired electrode shape (e.g., planar, triangular, rectangular, polygonal, oval, circular, solid non-planar with cross-section(s) that is(are) planar as aforelisted, open non-planar such as tubular, spiral, toroidal, and compound structures of the aforementioned types).

An electrode formed of a material that includes tape components (e.g., a carbon-carbon composite material), as discussed above, generally has a higher density (i.e., lower porosity) than prior art electrodes. For comparison, a conventional carbon-carbon composite material that includes fibers of primarily circular cross-section (e.g., an aspect ratio >95%) may have a theoretical maximum density of 90% (e.g., seven identical perfect circles within a hexagon boundary). Conventional packing of fibers produced by melt spinning produces bulk material having a density of about 65%. Since commercially available circular K1100 fiber has a density of 2.20 g/cc, the practical packing of 65% corresponds to a bulk material density of 1.43 g/cc.

In contrast, bulk material for an electrode as taught herein has a density, in one configuration, of about 1.9 g/cc. This higher density is a consequence of one or more of the following factors: the greater packing densities of tape (as compared to fibers of circular cross section), lesser use of binder, larger cross-sectional area of individual fibers (e.g., tape is less subject to surface cracking than conventional fiber of circular cross section), use of tape having a relatively high density prior to being formed into bulk material, and process steps used to form the tape and the bulk material as discussed below. In other configurations, bulk materials according to various aspects of the present invention have density in the range of from 1.3 to 2.1 g/cc, preferably in the range from 1.7 to 2.1 g/cc, and more preferably in the range from 1.9 to 2.1 g/cc.

The aspect ratio of each of one or more tape components as evident in a cross section of bulk material is greater than 1, preferably in the range from 40 to 8000, more preferably in the range from 50 to 5000, and still more preferably in the range from 500 to 2500.

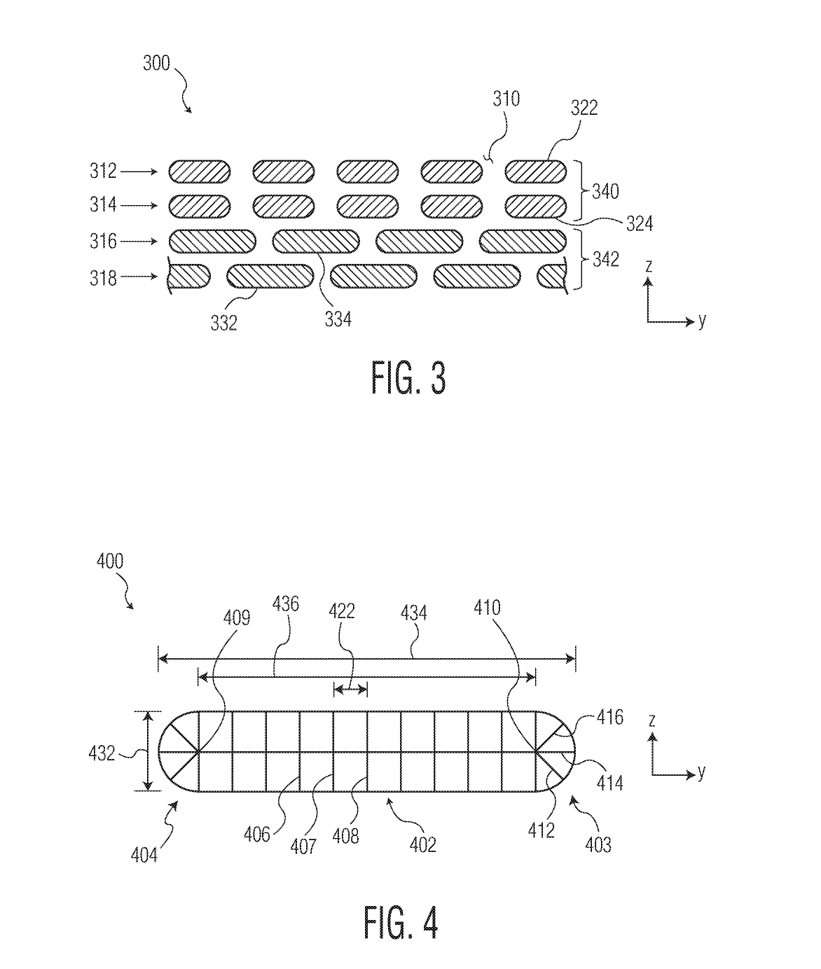

For example, the diagram of FIG. 3, (not to scale), illustrates a cross-section of composite material 300 of anode 236. Cross-section 300 includes matrix 310 (throughout the entire diagram) and a plurality of components, each component (e.g., 322 and 332) being a length of tape as discussed above. Components are integral with matrix 310. Components are arranged in rows 312, 314, 316, and 318 stacked in the z-axis. Spacing between components (i.e., a thickness of matrix between components) is not to scale.

Tape components of cross-section 300 include carbon (e.g. graphite and/or graphene) more highly organized than the carbon of matrix material 310. Due to the higher internal organization of each tape component, transport of ions for intercalation and deintercalation is facilitated to a greater extent in and through tape components than transport of ions in and through matrix 310 (e.g., random orientation). An amount of matrix 310 between some or all components (not shown) may be zero (i.e., components abut each other along some to all of the adjacent lengths of the components). The thickness of matrix 310 between components may be selected for desirable cohesion among components (e.g., to resist cracking of the electrode). In one configuration, the thickness of matrix 310 between components in any direction is less than the thickness of a component (e.g., 1% to 10%).

In one configuration, all rows are formed of components having functionally the same cross-sectional area and aspect ratio. For example, configuration 340 includes rows 312 and 314. The components (e.g., 322) of rows 312 and 314 (10 as shown) are arranged in the matrix 310 in a regular repeating order having rectangular symmetry among all components and rows of the configuration. In the rectangular symmetry, each component is juxtaposed to only one other component in the direction of the z-axis and only one other component in the direction of the y-axis.

In another configuration, all rows are formed of components having functionally the same cross-sectional area and aspect ratio. For example, configuration 342 includes rows 316 and 318. The components (e.g., 332) of rows 316 and 318 (6 as shown in full and 3 as shown in part) are arranged in the matrix 310 in a regular repeating order having primarily parallelogram symmetry among all components and rows of the configuration. In the parallelogram symmetry, some components are juxtaposed to more than one other component in the direction of the z-axis.

In yet another configuration (as shown), some rows of cross-section 300 are formed per configuration 340, discussed above, and some rows of cross-section 300 are formed per configuration 342, discussed above.

The thickness of the tape components on an anode 236 may be uniform as shown in FIG. 3. In another configuration tape components of two or more thicknesses are used. For example, in z-axis distribution of thicknesses, tape components in rows 312 and 316 may have a reference thickness and tape components in rows 314 and 318 may have a thickness less than the reference thickness. In configurations using z-axis distribution of thicknesses, a first group of 2 or more contiguous rows may have a reference thickness and a second group of 2 or more rows may have a thickness less than the reference thickness.

Note that in the configurations discussed above, intercalation and deintercalation are facilitated on the z-axis (either direction) due to orientation of the tape components' width being primarily along the y-axis. With reference to FIG. 2, note that the tape components of anode 236 have width primarily parallel to cathode portions 232 and 234.

Carbon tape as discussed as a component above may be formed to include one or more of various organizations of planar sheets of carbon. Each planar sheet of carbon refers to carbon organized as graphite and/or graphene. A plurality of planar sheets of carbon refers to an open crystalline material comprising graphite and/or graphene. These organizations are recognizable for example in cross-section via a scanning electron microscope and include one or more of the orientations conventionally referred to as line, radial, onion skin, flat layer, radial folded, and random orientations. For the function of intercalation and deintercalation, each planar sheet in so called parallel line orientation may essentially span the width of the tape (not shown). For the function of intercalation and deintercalation, each planar sheet in so called perpendicular line orientation may essentially span the thickness of the tape (as represented in FIG. 4). Perpendicular line orientation and radial orientation of planar sheets facilitate intercalation and deintercalation as discussed herein. These orientations may facilitate mass transport of ions in and through a component and/or electrode (e.g., anode 236) by reducing the length of diffusion paths and migration paths.

For example, the diagram of FIG. 4 (not to scale) illustrates a cross-section 400 of a component (e.g., 322, 324, 332, 334) of anode 236. Cross-section 400 identifies surface 402, and longitudinal edge portions 403 and 404. Cross-section 400 primarily includes perpendicular line orientation. Surface 402 lies primarily along the width 434 (y-axis) of the component and extends on the longitudinal axis of the tape (e.g., primarily in the x-y plane). Longitudinal edge portion 403 (404) represents a longitudinal edge of a component (e.g., 322, 324, 332, 334) that includes radial orientation extending from center of curvature 409 (410) of the edge of the component. Cross-section 400 has a thickness 432 in the z-axis. Cross-section 400 has an aspect ratio calculated as the ratio of width 434 divided by thickness 432. Dimension 436 corresponds to the difference between width 434 and thickness 432.

As used herein, fiber refers to a monofilament having a longitudinal axis. Fibers having an aspect ratio greater than 1 are referred to as tape. The term tape generally refers to extrudate after stabilization.

Adjacent planar sheets of carbon 406, 407, and 408 represent a few graphite and/or graphene layers in perpendicular line orientation (e.g., planes that are primarily parallel to the x-z plane). In a preferred configuration, planar sheets of carbon 406, 407, and 408 are representative of more than 90% of the material of a component (e.g., 322, 324, 332, 334). Planar sheets of carbon 412, 414, and 416 are representative of graphite and/or graphene layers in radial orientation. In a preferred configuration, planar sheets 412, 414, and 416 are representative of more than 90% of the material of longitudinal edge portions 403 and 404.

Adjacent planar sheets 406 and 407 (407 and 408) are spaced from each other a distance 422 (greatly exaggerated for clarity of presentation), corresponding to the space between graphite and/or graphene layers conventionally referred to as the interplanar spacing (e.g., d-value, d space, d₀₀₂). Ions proceed into anode 236 for intercalation and proceed out of anode 236 for deintercalation via the interplanar spacing. Orientation of the interplanar spacing to be open for ion movement primarily parallel to the z-axis facilitates intercalation and deintercalation as discussed above.

Longitudinal edge portion 403 (404) includes an orientation of planar carbon sheets 412, 414, and 416 (greatly exaggerated for clarity of presentation) referred to as radial. This orientation may be promoted by extruding the component through a rectangular slot-shaped die at a relatively high shear rate and drawing the extrudate along the longitudinal axis. In contrast, lower shear rates and draw ratios tend to produce parallel line orientation of sheets of carbon primarily parallel to the y-axis.

According to various aspects of the present invention, tape components used in bulk material for an electrode have a greater cross-sectional area evidencing primarily perpendicular line orientation than a cross-sectional area evidencing primarily radial orientation. While FIG. 4 represents a model cross-section, and actual tape cross-sections may be less regular (e.g., thinner in the center at 408 as a dumb bell shape, wavy or uneven thickness), a ratio of cross-sectional areas (i.e., a figure of merit, M) is characteristic of tape components in some configurations according to various aspects of the present invention. For example, a first area of radial orientation may be calculated as the areas of end portions 403 and 404, that is, pi times the radius given by half the thickness 432. A second area of perpendicular line orientation may be calculated as the product of thickness 432 dimension 436. The total area is the sum of the first area and the second area. For the model of FIG. 4, with an aspect ratio of 2, the figure of merit (M) of the second area to the first area would be 4 divided by pi (i.e., greater than 1.27). For large aspect ratios, the figure of merit is approximately 1.27 times the aspect ratio.

An aspect ratio greater than 2 facilitates accurate placement of tape components into a mold as discussed below. A figure of merit (M) greater than 2.5 facilitates intercalation and deintercalation as discussed below. According to various aspects of the present invention, a cross-section of a tape component has a figure of merit (M) in the range from 50 to 10700, more preferably in the range from 60 to 6400, still more preferably in the range from 600 to 3200.

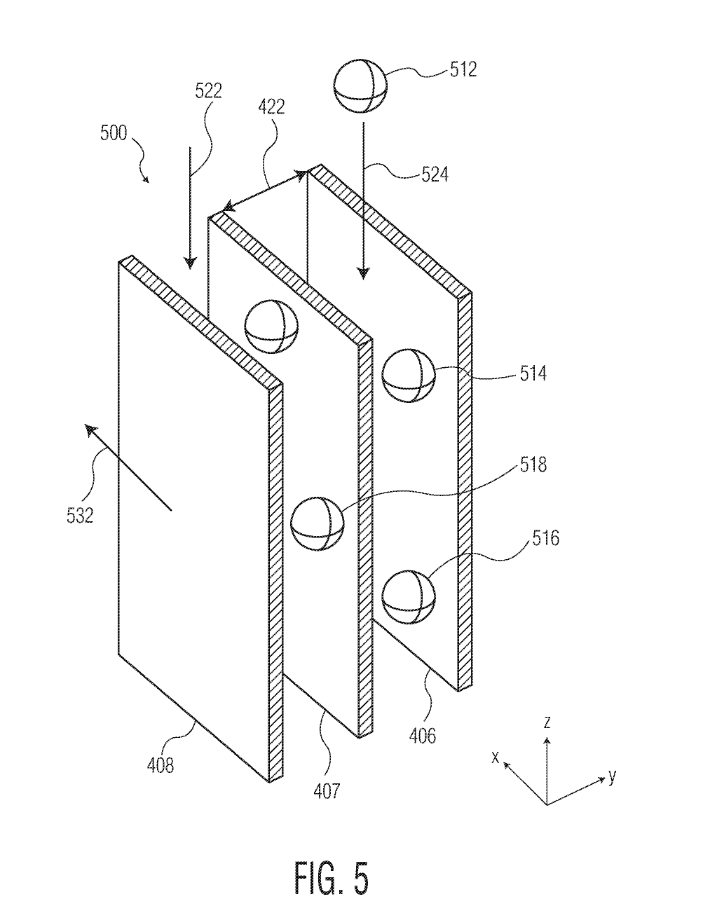

Intercalation and deintercalation are illustrated in the diagram of FIG. 5 (not to scale). A plurality of planar sheets of carbon 500 as shown includes sheets sheets 406, 406, and 408 separated regularly by distance 422. Intercalation involves ions (e.g., lithium, sodium, alkali metal) received through the separator (e.g., ion 512) into the interplanar spacing (422) and lodging between adjacent planar sheets of carbon. During intercalation, electrons flow in the sheets 406, 407, and 408 (equivalently 506, 507, and 508) in the direction of arrow 532 (primarily parallel to the x-axis). For example, ion 512 is provided via separator 242 and is being inserted toward anode 236 in the direction of arrow 624 (primarily parallel to the z-axis). Ion 518 entered anode 236 between sheets 407 and 408 by being inserted toward anode 236 in the direction of arrow 522 (primarily parallel to the z-axis). Ions 514 and 516 are lodged between sheets 406 and 407, having been inserted in the direction of arrow 524. Extraction of ions 514, 516, and 518 would proceed in the directions opposite to arrows 522 and 524.

Anode 236 of FIGS. 2 through 5 has a continuous external surface that includes a first active region 250, a second active region, and two or more inactive regions. Each region is identified by a primary function performed within the region (e.g., intercalating ions, deintercalating ions, conducting electricity, providing structural support to another region, providing support for a terminal). A region is deemed active when primarily performing the function of intercalating and/or deintercalating ions. For example, region 250 is an active region as a consequence of being in contact with electrolyte (242 or 244). Inactive regions include, for example, regions for attaching a terminal, as discussed above, and edges of anode 236. An active region of an external surface includes the portion of the external surface and material juxtaposed to the external surface that is involved in performing the function of the region. For example, an active region for intercalation may include a plurality of planar sheets of carbon in primarily perpendicular line orientation to facilitate intercalation. The active region may further include matrix material, for example, between the surface and a row of tape components in the matrix, and/or between rows of tape components in the matrix.

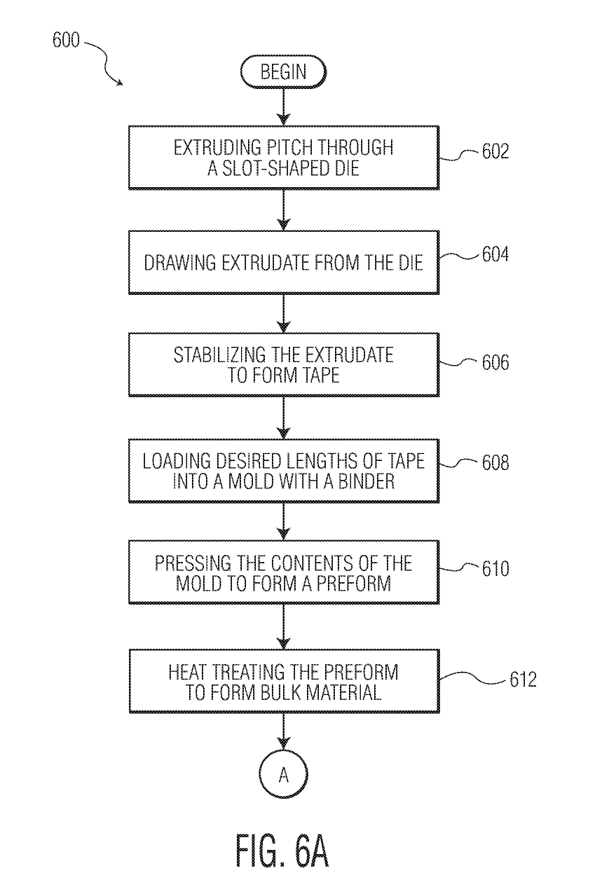

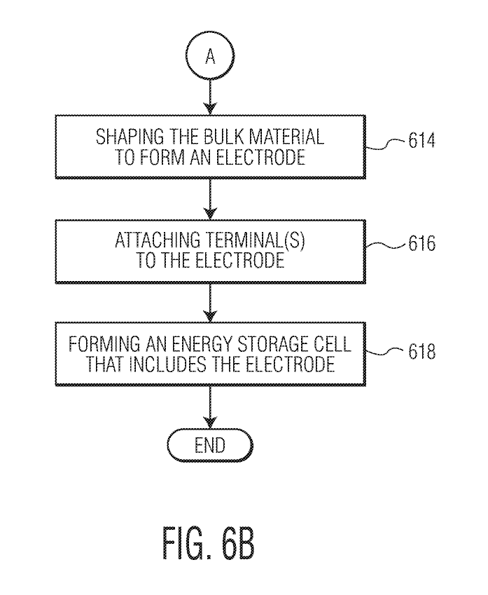

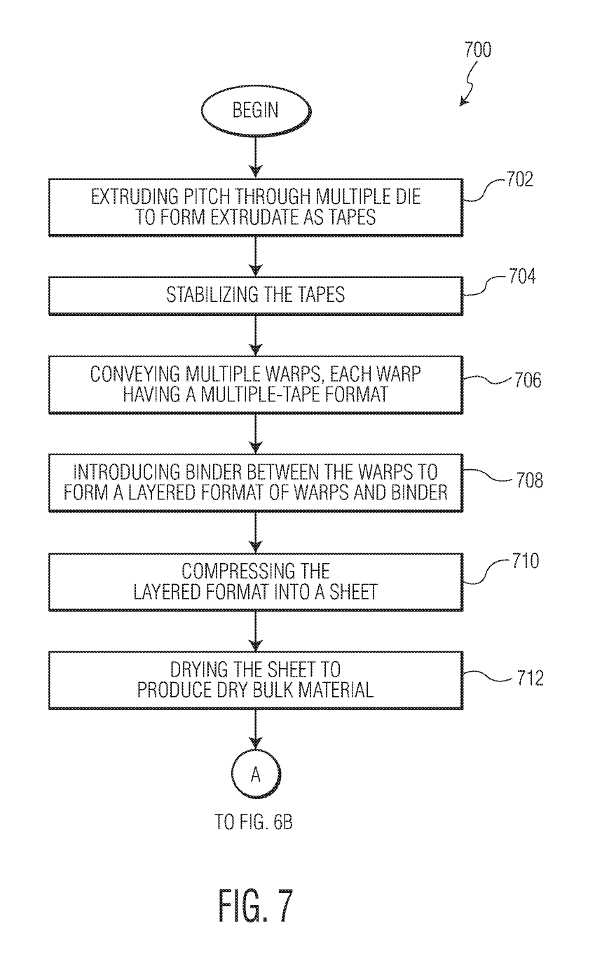

Several methods will be discussed with reference to FIG. 6 as an outline. These methods differ for example as to which steps of the flow 600 are included and processes involved with each included step. Methods, according to various aspects of the present invention, may involve forming tape as a component discussed above, a preform, bulk material, an electrode, or an energy storage cell as discussed above. For example, flow 600 of FIG. 6 includes extruding (602) pitch through a slot-shaped die, drawing (604) extrudate from the die, stabilizing (606) the extrudate to form tape, loading (608) desired lengths of tape into a mold with a binder, pressing (610) the contents of the mold to form a preform, heat treating (612) the preform to form bulk material, shaping (614) the bulk material to form an electrode, attaching (616) terminal(s) to the electrode, and forming (618) an energy storage cell that includes the electrode.

The steps of extruding (602), drawing (604), and stabilizing (606) comprise a first process for producing tape that may be marketed as an intermediate product. Such tape may have an organization of the type discussed above with respect to FIGS. 4, 5, and/or 6. The steps of loading (608) and pressing (610) begin with the tape and comprise a second process for producing a preform that may be marketed as an intermediate product. The step of heat treating (612) begins with the preform and comprises a third process that produces bulk material that may be marketed as an intermediate product. The step of shaping (614) begins with the bulk material and comprises a fourth process that produces an electrode that may be marketed as an intermediate product. Finally, the steps of attaching (616) and forming a cell (618) begin with an electrode and comprises a fifth process that produces an energy storage cell. Other methods, according to various aspects of the present invention, include various combinations of these processes.

Extruding (602) includes any process involving moving a mass of soft solid material through a die. The solid material may be loaded into a crucible, heated above its softening point, and forced through an aperture of the die. A conventional carbonaceous fiber manufacturing process may be used as modified by the disclosures herein (e.g., melt spinning, melt blowing). A conventional melt-extrusion system may be used. The die includes an aperture, preferably slot-shaped (e.g., as an oval, ellipse, rectangle, parallelogram, trapezoid, elongated polygon) having an aspect ratio of maximum width (y-axis) divided by maximum thickness (z-axis). The thickness of the extrudate is dictated in part by the depth of the aperture of the die, that if too large, may lead to departure from a preferred orientation of planar carbon sheets, discussed below. A maximum width of the aperture of the die has not been determined. The aspect ratio (width to depth) may be in the range from 10 to 1000, preferably greater than 50, for example in the range from 300 to 500. The width of the aperture may be in the range from 7.5 to 25 mm, preferably in the range from 7.5 to 10 mm. The depth of the aperture may be in the range from 20 microns to 1 mm, preferably in the range from 0.1 to 0.15 mm.

The shear rate of extruding (602) may contribute to the formation of the planar carbon sheets in an orientation perpendicular to the longitudinal axis of the extrudate. The shear rate may be in the range from 5,000 to 33,000 per second. For an aperture with aspect ratio about 50, shear rate is preferably in the range from 5,000 to 11,100 per second. For an aperture with aspect ratio about 80, shear rate is preferably in the range from 6,600 to 12,600 second. Shear rate is defined by equation 1.

$${R}_{shear} = \frac{4 ⋆ Q}{π ⋆ {r}^{3}} \qquad ( 1 )$$

wherein: Rₛₕₑₐᵣ is the shear rate at an edge of the aperture
Q is the volume flow rate in cubic meters per second
r is the hydraulic radius; for a rectangular slot use twice the slot area divided by the perimeter of the slot

For example, the input mass of soft solid material may consist essentially of mesophase pitch (e.g., synthetic, naphthalene derived), having a softening point of 210 to 270° C., preferably about 235 to about 265° C. Anisotropic content may be in the range from 90 to 100 wt %, preferably about 100 wt %. Mesophase pitch of the type marketed by Mitsubishi Gas Chemical Co. as model ARA 24 may be used. The solid material may be heated from 105% to 120% of the softening temperature to form a melt, for example, heated to a temperature in the range 280 to 330° C. The melt may be moved through the die by nitrogen gas at a pressure determined to accomplish the desired shear rate, for example, a pressure in the range from 0.2 to 1.0 MPa, preferably about 0.8 MPa. The aperture of the die may have a depth extending along the direction of extruding in a range from 0.015 to 0.5 mm, preferably in a range from 0.015 to 0.15 mm.

Drawing (604) includes any process involving pulling the extrudate from the die. Drawing may be accomplished at an atmospheric temperature in the range of 20 to 30° C. Drawing may be accomplished in an atmosphere that includes oxygen (e.g., ambient air). Drawing may include pulling the extrudate between conventional pinch rollers (e.g., preceding a cutting tool to cut the extrudate into lengths). Pulling may involve the force of gravity on the extrudate. Pulling may involve a force of momentum (e.g., centrifugal force). Drawing may include winding the extrudate onto a spool using conventional technology.

For example, in one configuration, the die is positioned in a horizontal plane, and extruding 602 proceeds in a vertical downward direction, so that the force of gravity provides at least some of the force that draws the extrudate from the die.

Extrudate may have a final dimension width in the range from 3 to 25 mm; and a final dimension thickness in the range from 10 to 25 microns. Higher aspect ratios facilitate proper alignment of individual lengths of tape, for example on a flat surface.

Extruding (602) may include winding the extrudate onto a spool (along a tangent having a radius). The spool may be driven by a servo motor, sensors, and controller that maintains a force on the extrudate independent of the radius. Winding may maintain a draw ratio in the range from 4 to 8, preferably about 5. The draw ratio is defined by equation 2.

$${R}_{draw} = \frac{{θ}_{slot}}{{θ}_{extrudate}} \qquad ( 2 )$$

wherein: R_{draw} is the draw ratio
θₛₗₒₜ is the thickness of the aperture
θ_{extrudate} is the thickness of the extrudate

The spool may include a coolant to cool the extrudate, for example, as conventionally accomplished in melt-spinning. Cooling may include controlling the temperature of the coolant using conventional technologies. Extrudate may be wound onto a surface comprising a conventional carbon felt. A higher degree of preferred orientation of carbon planar sheets may result from relatively slower cooling than used in conventional melt-spinning processes.

The spool may have a cross-section corresponding to an oval, circle, or polygon. When the spool cross-section corresponds to a polygon, a surface of the spool may facilitate storing relatively flatter lengths of extrudate than on a curved surface. A side of the polygon may correspond to a desired length discussed below with reference to loading (608).

Stabilizing (606) may include any process that reduces a risk of deformation of the as-spun extrudate and/or reduces an adhesion or cohesion characteristic of the extrudate. The stabilized extrudate is herein called a tape. Stabilizing may include oxidation. Stabilizing may include carbonizing. Stabilizing may include graphitizing. Conventional technologies (e.g., temperature chamber(s)) used for stabilizing fiber of round cross-section may be used to accomplish stabilizing tape, further including adjustments for the tape dimensions as discussed herein (e.g., temperatures, soak durations).

For example, oxidation may be accomplished by heating the extrudate in an oxygen containing atmosphere (e.g., ambient air, air or nitrogen supplemented with oxygen) to facilitate uptake of oxygen into the tape. The atmosphere may be maintained at a temperature in the range from 200 to 350° C., preferably below 300° C. (e.g., from 240 to 250° C.), for a period sufficient for a weight gain of the tape in the range from 6 to 10 wt %, preferably 7 to 8 wt % (e.g., a period in the range from 10 to 20 hours).

Stabilizing may further include heat treating to reduce the risk of breakage of the extrudate or tape due to shrinkage during hot pressing. Heat treating may include heating stabilized tape to a temperature of about 450° C. for a period of about 1 hour in a nitrogen atmosphere. Heat treating may accomplish carbonizing for example using a temperature in the range from 800 to 1200° C., preferably about 1000° C. Heat treating may also accomplish graphitization for example using a temperature in the range from 2800 to 3200° C., preferably about 2800° C.

Loading (608) tape and binder into a mold may be accomplished manually and/or with conventional materials handling apparatus, for example, programmed with conventional technology, to accomplish a cross-section of the type discussed above with reference to FIG. 3). The mold may be formed of stainless steel.

For example, tape portions of desired length(s) are prepared by cutting (e.g. shearing, sawing, abrading) tape formed as discussed above. Cutting may be unnecessary when the tape was cut to a suitable length as discussed above with reference to drawing (604).

Binder includes any material that combines separable lengths of tape into a unified structure. Binder is porous so that it facilitates movement of electrolyte and ions for intercalation and deintercalation. A conventional binder (e.g., polyvinylidene fluoride (PVDF), styrene-butadiene rubber (SBR), carboxymethyl cellulose (CMC)) may be used. Binder may be distributed (e.g., sprayed, coated, sprinkled) onto tape portions before or after tape portions are placed in the mold. Binder (e.g., 200 mesh screen powder) may include mesophase pitch of the type discussed above, prepared by crushing the pitch in a conventional hammer mill. Conductive material may be included in the binder (e.g., graphite particulate, carbon nanotubes, metallic particulate) using conventional technologies.

Binder in powder form may be mixed with isopropyl alcohol (e.g., 1:8 by volume) to form a spray. Sprayed tape portions may be dried in air prior to loading (608).

Increasing the amount of binder in the loaded mold may improve the strength of the bulk material. However, decreasing the amount of binder in the loaded mold may improve the intercalation and deintercalation functions of an electrode formed of the bulk material. The amount of binder in the mold may be up to 30 wt %, preferably less than 20 wt %, more preferably in the range from 2 to 10 wt %.

Loading (608) includes placing tape portions in a mold in parallel to each other as an arrangement of the type discussed above with reference to FIG. 3. The length(s) of the tape portions and the number of rows may correspond to the desired dimensions of one or more electrodes (e.g., one anode 236). Tape portions may be of the same cross-section (configuration 340 or configuration 342) or of a mix of cross-sections (a mix of configurations 340 and 342).

In one configuration, a layer of tape portions is loaded into a mold. Binder is then distributed in the mold. The loading of tape portions and distributing of binder is repeated until the desired depth of the mold is filled.

Pressing (610) includes conventional hot pressing technology and may be performed using conventional hot pressing equipment. Heat and pressure are determined to facilitate formation of a preform with structural integrity sufficient for materials handling and further processing steps. The combination of heat and pressure may soften the tape.

For example, pressing may include applying pressure in the range from 15 to 35 MPa to the mold on one axis (e.g., along the z-axis) at a temperature in the range from 400 to 500° C. for a period of from 2 to 5 hours. In one configuration, pressure at about 10 MPa was applied at about 450° C. for about 5 hours. In another configuration, a rectangular mold is placed in a press capable of from 5 to 10 tons and pressed at a temperature of about 400° C. for about 2 hours. The preform is thereafter removed from the mold for further processing.

Heat treating (612) includes any process that converts a preform into a carbon-carbon composite material as discussed above, without adversely affecting the orientation of planar carbon sheets of the tape components. Heat treating may include conventional technologies and be performed in a temperature chamber. Heat treating may include conventional carbonizing and conventional graphitizing. For example, carbonizing may include heating at a rate of about 10° C. per hour to a temperature in the range from 700 to 1600° C. (preferably about 1000° C.) in an inert atmosphere (e.g., argon, nitrogen). For example, graphitizing in the same or a different temperature chamber may include forming an atmosphere (e.g., by vacuum purging and refilling) primarily of inert gas (e.g., argon, nitrogen) at a pressure of about 0.1 MPa, then heating to a temperature in the range from 2700 to 3100° C. (preferably about 3000° C.) for a period of about 15 minutes. The temperatures and durations for carbonizing are sufficient to drive out non-carbon atoms. The temperatures and durations for graphitization are sufficient to produce in the graphitized bulk material carbon layers (e.g., graphite, graphene) as discussed herein.

Ehen binder includes a thermoset resin (e.g., phenolic, epoxy), pressing (610) may include applying pressure in the range from 0.7 to 1.4 MPa and heat treating (612) may include heating to a temperature in the range from 60 to 100° C. Pressing (610) and heat treating (612) may continue for a duration in the range from 1 to 4 hours.

In one implementation binder is carbonized and graphitized as a result of pressing (610) and heat treating (612).

In a preferred implementation, tape components that have been stabilized as discussed above (e.g., oxidizing, carbonizing, graphitizing) may be coated with binder (e.g., PVDF, CMC) and conductive material (e.g., graphite particulate, carbon nanotubes, metallic particulate), and formed into a preform. Formation may include a mold. Formation may be a continual process (e.g., moving warps, moving substrate, use of webs) without a mold. Formation may include applying pressure (710) in the range from 0.03 to 0.7 MPa and temperature (712) in the range from 35 to 80° C. The resulting preform or sheet is then ready for shaping (614) (e.g., into electrodes, into anodes).

Shaping (614) includes any process that produces one or more shaped electrodes having final desired dimensions (in x, y, and/or z axes) from the preform or sheet material discussed above. Any conventional shaping technology may be used (e.g., cutting, shearing, abrading, sawing, planing). When the preform or sheet material is of the type referred to as a web, conventional numerically controlled shaping may be used to provide individual electrodes. When the preform or sheet already has desired dimension, the shaping process may be omitted.

In one configuration, an electrode is formed from a plurality of layers. Layers may be marketed, for example, on a removable substrate. A plurality of layers removed from the substrate may be loaded into a mold, with binder as desired, and subject to heat treating and shaping as discussed above.

Attaching (616) one or more terminals to an electrode may be accomplished using conventional technologies that are suitable for the desired type of terminal(s). For example, a conductive tab may be attached as discussed with reference to tabs 107 and 109 above.

Forming an energy storage cell includes any conventional technologies for placing electrodes, and separator(s) into ionic communication to form an assembly within a sealed enclosure. An energy storage cell may be formed in a format known as 18650 for laptop computers, LED flashlights, electronic cigarettes, and electric vehicles (e.g., model S marketed by Tesla Motors, Inc.). For example, forming (618) a lithium ion energy storage cell includes placing at least one anode as discussed herein with reference to FIGS. 1 through 5 in electro-chemical communication with one or more separators that are in electro-chemical communication with one or more cathode portions, as discussed above. The combination of anode(s), separator(s), and cathode portion(s) is enclosed in an enclosure as discussed above. Placement, enclosing, and sealing of the enclosure may be accomplished using any conventional technologies including manual, automated, and parallel manufacturing of one or more webs.

In a configuration based on webs, each web may include a plurality of one component (e.g., anode, separator, cathode portion) or a combination of these components (e.g., for placement by folding as with a clam-shell). In one configuration, 7 webs (i.e., 202, 232, 242, 236, 244, 234, 204) are aligned and stacked to simultaneously form a desired quantity of assembly 104 within enclosing portions 202 and 204.

Energy storage cells, according to various aspects of the present invention include cells that involve the intercalation and deintercalation of sodium ions in an anode as discussed above.

An energy storage cell, in one configuration includes one or more anodes, each anode comprises one tape component (as discussed above) for intercalation and deintercalation. A method in one configuration of forming such a cell includes the steps of extruding (602), drawing (604), stabilizing (606), heat treating (612), and forming (618), as discussed above. Other steps of flow 600 are omitted. In other configurations, the steps of shaping the tape component (similar to 614) and/or attaching one or more terminals (616) are included.

Methods, according to various aspects of the present invention, may involve forming tape as a component discussed above, forming a warp comprising many parallel separable tapes, forming a sheet of tapes bound together, forming bulk material, forming an electrode, and/forming an energy storage cell as discussed above. For example, flow 700 of FIG. 7 includes extruding (702) pitch to form extrudate as tapes, stabilizing (704) the tapes, conveying (706) multiple warps of tapes, introducing (708) binder between the warps to form a layered format, compressing (710) the layered format into a sheet, and drying (712) the sheet to form bulk material. The bulk material may be used in a continuation of flow 700 as discussed above with reference to FIG. 6B.

Extruding (702) an input mass comprising mesophase pitch through multiple die to form extrudate as tapes may be accomplished by concurrently extruding through multiple die arranged to facilitate handling and/or further processing of multiple tapes. Extruding (702) may include drawing multiple issues of extrudate from multiple slot-shaped openings of one or more die. A die having multiple slot-shaped openings, one for each extrudate, may be used. Several die may be used concurrently, each die having one or more slot-shaped openings. Extruding (702) to form tapes may be accomplished through each slot-shaped opening in a manner as discussed above with reference to extruding (602). Die used in extruding (702) may be formed as discussed above with reference to extruding (602) and drawing (604).

Extruding (702) further includes controlling the consistency of input mesophase pitch material, controlling the feed available for each slot shaped opening, and/or controlling the temperature and/or pressure of the feed through each slot-shaped opening. Controls constructed of conventional sensors and analog circuitry and/or digital circuitry and software may be used. Controlling assures dimensional uniformity of the tapes with respect to each other, and/or assures dimensional uniformity along the length of each tape.

By extruding (702) through multiple slot-shaped openings, concurrently produced tapes may be rolled onto a reel and stored or processed in a side-by-side tape format, such as onto a reel having a circumferential channel for each tape. The side-by-side arrangement facilitates formation of a warp of tapes as discussed below. Processing may include removing the tapes from an input reel, performing a process (e.g., one or more portions of the process of stabilizing (704)), and rolling them onto an output reel.

Stabilizing (704) the tapes after extruding may be accomplished by stabilizing multiple tapes concurrently. The tapes may be arranged in a warp for stabilizing. Stabilizing may include oxidizing, carbonizing, and/or graphitizing, as discussed above with reference to stabilizing (606).

A warp comprises a multiple-tape format (e.g., side-by-side arrangement, substantially length-parallel arrangement, substantially length-co-planar) of many individual, separable tapes, arranged in a manner similar to the warp of a textile loom. Under lengthwise tension (e.g., x-axis, length as extruded), the warp may seem planar. Movement of the warp entails movement of all tapes of the warp in a manner with reduced opportunity for misalignment or strain of individual tapes.

The tape components of a warp may have uniform dimensions (e.g., width, thickness). The tape components of a warp may have non-uniform dimensions (e.g., two or more widths, two or more thicknesses). Portions of warps to be juxtaposed may have uniform tape component dimensions (e.g., width, thickness). Portions of warps to be juxtaposed may have non-uniform dimensions (e.g., two or more widths, two or more thicknesses).

Conveying (706) multiple warps maintains and accomplishes alignment for further processing, discussed below. Each warp has a multiple-tape format that may be maintained during conveying. Conveying may include supporting multiple reels of tapes, and supplying tapes as warps. Each reel may supply a portion or all of a warp. A reel may supply more than one warp. The alignment of warps relative to each other may be maintained during conveying. Conveying may be accomplished concurrently with introducing (708), compressing (710), and/or drying (712), discussed below.

Introducing (708) binder between at least two warps forms a layered format of warps and binder. Introducing (708) may include introducing binder between any practical number of warps as desired for the formation of layered sheet and/or bulk material, discussed below. Binder may be introduced by sprinkling powdered binder, spraying an aerosol born binder, and/or applying a liquid born binder (e.g., running a warp across a wave of liquid, running a warp across a roller that dispenses liquid). Binder as used in conventional lithium cell anodes may be used (e.g., PVDF, CMC, SBR). Binder may include conductive material as discussed above.

For an anode for use in a lithium cell, one or more sheets may be produced by compressing (710) a layered structure of warps and binder. A group of warps may have a cross-section similar to the cross-section described with reference to FIG. 3. Warps may be conveyed (706) into a process of compressing (710) in a manner that determines and maintains the alignment of juxtaposed tapes as described with reference to FIG. 3. Conveying (706) may produce a layered format suitable for compressing (710).

Compressing (710) a layered format of warps and binder produces a sheet. Each warp may form one layer of the layered format. The quantity of layers of tapes (the quantity of warps) for an anode for use in a lithium cell may be in the range from 2 to 20, preferably from 4 to 6.

In an implementation using binder to be carbonized and graphitized, pressure in the range from 15 to 35 MPa and temperature in the range 400 to 500° C. is applied to the layered format for a duration in the range from 2 to 5 hours.

In another implementation, pressure of about 10 MPa and temperature of about 450° C. is applied for a duration of about 5 hours. Conventional compression rollers may be used to accomplish compressing a moving layered format to produce a moving sheet.

In another implementation, binder is not carbonized or graphitized. Advantageously, compressing (710) and drying (712), consequently involve lower pressure, lower temperature, and shorter duration.

Drying (712) a sheet, produced by compressing (710), may be accomplished by conveying and/or holding the sheet at a temperature in the range from 36 to 66° C. for a duration in the range from 0.25 to 2 hours. Longer duration may be suitable for sheets having considerable thickness. Drying produces dry bulk material that may be in the form of one or more sheet(s) being continuous or separate (e.g., of a desired maximum length). This material may be used to form an electrode and further to form an energy storage cell as discussed above with reference to FIG. 6B.

The foregoing description discusses preferred embodiments of the present invention, which may be changed or modified without departing from the scope of the present invention as defined in the claims. The invention includes any practical combination of the structures and methods disclosed. The examples listed in parentheses may be alternative or combined in any manner. The term ‘about’ means plus or minus 5%. The terms ‘primarily parallel’ and ‘primarily perpendicular’ mean the range of angles plus and minus 10 degrees from parallel and perpendicular, respectively. The term ‘primarily’ when not referring to an angle means plus or minus 5%. The term planar does not imply all characteristics of a mathematical plane (e.g., zero thickness, perfectly flat, extending to infinity); instead it is used to emphasize a relationship between adjacent sheets that facilitates intercalation and deintercalation (e.g., d space primarily uniform) regardless of thickness, curvature, and finite extent. The term ‘or’ as used in the specification and claims means the open-ended inclusive-or not the exclusive-or and not a closed-ended expression. As used in the specification and claims, the words ‘of’, ‘having’, and ‘including’ in all grammatical variants are open-ended and synonymous with ‘comprising’ and its grammatical variants. While for the sake of clarity of description several specific embodiments of the invention have been described, the scope of the invention is intended to be measured by the claims as set forth below.

What is claimed is:

1. A method for making a preform for an electrode, the method comprising:
a. obtaining a plurality of fibers wherein each fiber has a respective longitudinal axis, a respective width and a respective thickness less than the width;
b. arranging the plurality of fibers in a length-parallel arrangement so that the width of each fiber faces an active region of a surface of the preform, the active region for admitting ions for intercalation; and
c. binding the plurality of fibers to maintain the arrangement, thereby producing the preform.

2. The method of claim 1 wherein each fiber comprises a plurality of carbon sheets juxtaposed to each other in primarily perpendicular line orientation.

3. The method of claim 2 wherein the perpendicular line orientation of each fiber is perpendicular to the respective width of each fiber.

4. The method of claim 1 wherein obtaining the fiber comprises:
a. extruding a mass comprising mesophase pitch through a slot-shaped die;
b. drawing extrudate from the die; and
c. stabilizing the extrudate to form the fiber.

5. The method of claim 4 wherein stabilizing comprises one or more of oxidizing, carbonizing, and graphitizing.

6. The method of claim 1 wherein arranging comprises placing respective lengths of fiber into a mold.

7. The method of claim 6 wherein:
a. the mold contains contents comprising the lengths of fiber and a binder; and
b. binding comprises carbonizing and graphitizing the contents of the mold.

8. The method of claim 1 wherein the arrangement comprises a warp of fibers.

9. The method of claim 8 wherein:
a. arranging comprises forming a first warp of a first portion of the plurality of fibers and forming a second warp of a second portion of the plurality of fibers; and
b. binding comprises introducing a binder between the first warp and the second warp.

10. The method of claim 1 wherein binding produces the preform comprising a carbon-carbon composite material.

11. The method of claim 1 wherein each fiber consists of a tape component.

12. The method of claim 1 wherein the preform has a density in a range from 1.3 to 2.1 grams per cubic centimeter.

13. A preform for an electrode, the preform comprising:
a. a plurality of carbon fibers in a length parallel arrangement; wherein
b. each fiber comprises a plurality of carbon sheets juxtaposed to each other in primarily perpendicular line orientation; and
c. the perpendicular line orientation facilitates intercalation.

14. The preform of claim 13 further comprising an open crystalline material that includes the plurality of fibers.

15. The preform of claim 14 wherein the material has a density in a range from 1.3 to 2.1 grams per cubic centimeter.

16. The preform of claim 14 wherein the material comprises a carbon-carbon composite.

17. The preform of claim 13 wherein each fiber is formed as a tape component having a respective width, the perpendicular line orientation being primarily perpendicular to the width.

18. The preform of claim 17 wherein:
a. each tape component has a respective longitudinal axis; and
b. the tape components are arranged in the preform so that the longitudinal axes are primarily parallel to each other.

19. The preform of claim 17 wherein:
a. each tape component has a respective width and a respective thickness less than the width; and
b. the tape components are arranged in the preform so that each respective width faces an active region of a surface of the preform.

20. An electrode for use in an energy storage cell operative with a provided load, the electrode having an external surface and having a portion of the external surface for use as an active region of the electrode for intercalation of ions, the electrode comprising:
a. a plurality of juxtaposed carbon sheets separated by a distance for intercalation of ions, the plurality arranged primarily parallel to a flow of ions through the active region for at least one of intercalation and deintercalation; and
b. means for transferring energy between the load and the plurality of carbon sheets.
